(19) United States
(12) Patent Application Publication
(10) Pub. No.: US 2015/0097546 A1
(43) Pub. Date: Apr. 9, 2015

(54) BIDIRECTIONAL DC-DC CONVERTER

(71) Applicant: National Tsing Hua University, Hsinchu (TW)

(72) Inventors: Ching-Tsai Pan, Hsinchu (TW); Chen-Feng Chuang, Hsinchu (TW)

(73) Assignee: National Tsing Hua University, Hsinchu (TW)

(21) Appl. No.: 14/137,628

(22) Filed: Dec. 20, 2013

(30) Foreign Application Priority Data
Oct. 9, 2013 (TW) 102136613

(51) Int. Cl. H02M 3/158

(52) U.S. Cl. CPC H02M 3/158
USPC 323/311

(57) ABSTRACT

A bidirectional converter circuit includes a voltage source which provides an input voltage, an energy storage set connected to the voltage source and receives the input voltage, a switch set connected to the energy storage set, wherein the switch set includes a first switch and a second switch; an operating switch set connected to the switch set, wherein the operating switch set includes a first operating switch, a second operating switch, a third operating switch and a fourth operating switch. The bidirectional converter further includes a blocking capacitor set and a (input/output) capacitor set. Wherein, the blocking capacitor set is connected to the switch set and the operating switch set. The first operating switch and the second operating switch are driven complementarily with the first switch, and the third operating switch and the fourth operating switch are driven complementarily with the second switch.

### BACKGROUND OF THE INVENTION

1. Field of the Inventions

The present invention relates to a non-isolated bidirectional DC/DC converter with high conversion ratio and low switch voltage stress characteristic, in particularly, to a novel transformer-less two-phase interleaved bidirectional DC/DC converter with high efficiency.

2. Description of Related Art

Recently bidirectional dc-dc converters (BDC) have received a lot of attention due to the increasing need to systems with the capability of bidirectional energy transfer between two dc buses. Apart from traditional application in dc motor drives, new applications of BDC include energy storage in renewable energy systems, fuel cell energy systems, hybrid electric vehicles (REV), uninterruptible power supplies (UPS), PV hybrid power systems and battery chargers.

Various BDCs can be divided into the non-isolated BDCs and isolated BDCs. Non-isolated BDCs (NBDC)are simpler than isolated BDCs (IBDC) and can achieve better efficiency.

For non-isolated applications, the non-isolated bidirectional DC-DC converters, which include the conventional boost/buck (step-up/step-down) types, multi-level type, three-level type, sepic/zeta type, switched-capacitor type and coupled-inductor type, are presented. The multi-level type is a magnetic-less converter, but more switches are used in this converter. If higher step-up and step-down voltage conversion ratios are required, much more switches are needed. This control circuit becomes more complicated. In the three-level type, the voltage stress across the switches on the three-level type is only half of the conventional type. However, the step-up and step-down voltage conversion ratios are low. Since the sepic/zeta type is combined of two power stages, the conversion efficiency will be decreased. The switched capacitor and coupled-inductor types can provide high step-up and step-down voltage gains. However, their circuit configurations are complicated. The interleaved structure is another effective solution to increase the power level, which can minimize the current ripple, can reduce the passive component size, can improve the transient response, and can realize the thermal distribution. For example, a two-phase conventional interleaved boost/buck converter is presented. However, the step-up and step-down voltage conversion ratios also are low.

### SUMMARY OF THE INVENTION

This invention presents a novel interleaved bidirectional DC-DC converter with low switch voltage stress characteristic for the low-voltage distributed energy resource applications. In boost mode, the module is combined with interleaved two-phase boost converter for providing a much higher step-up voltage gain without adopting an extreme large duty ratio. In buck mode, the module is combined with interleaved two-phase buck converter in order to get a high step-down conversion ratio without adopting an extreme short duty ratio. Based on the concepts of the voltage division and the voltage summation of the capacitor voltage, the energy can be stored in the blocking capacitor set of the bidirectional converter circuit for increasing the voltage conversion ratio and for reducing the voltage stresses of the switches. As a result, the invention converter topology possesses the low switch voltage stress characteristic. This will allow one to choose lower voltage rating MOSFETs to reduce both switching and conduction losses, and the overall efficiency is consequently improved. In addition, due to the charge balance of the blocking capacitor, the converter features automatic uniform current sharing characteristic of the interleaved phases without adding extra circuitry or complex control methods.

The present invention provides a bidirectional DC-DC converter, comprising: a voltage source for providing an input voltage; an energy storage set connected to the voltage source and receiving the input voltage; a switch set including a first switch and a second switch, wherein the first switch and the second switch are respectively connected to the energy storage set; an operating switch set connected to the switch set, wherein the operating switch set includes a first operating switch, a second operating switch, a third operating switch and a fourth operating switch; a blocking capacitor set respectively connected to the switch set and the operating switch set; and an output capacitor set receiving energy from the energy storage set and the input voltage and providing a power to a load; wherein, the first operating switch and the second operating switch are driven complementarily with the first switch, and the third operating switch and the fourth operating switch are driven complementarily with the second switch.

The present invention utilizes voltage adding and voltage dividing concept of the capacitor to increase the conversion ratio for boost or buck, and further reduce the switch across voltage. Therefore, the circuit can use the elements with lower switch cross voltage in order to reduce the switching loss and conduction loss to increase the conversion efficiency of the converter.

### BRIEF DESCRIPTION OF THE DRAWINGS

FIG. 1 is a schematic diagram of an interleaved bidirectional DC-DC converter circuit showing embodiment of the invention;

FIG. 2(a) is an equivalent circuit of the interleaved bidirectional DC-DC converter showing the operating mode 1 and mode 3 under the step-up mode of the invention;

FIG. 2(b) is an equivalent circuit of the interleaved bidirectional DC-DC converter showing the operating mode 2 under the step-up mode of the invention;

FIG. 2(c) is an equivalent circuit of the interleaved bidirectional DC-DC converter showing the operating mode 4 under the step-up mode of the invention;

FIG. 3 key waveforms of the converter operating at CCM which include gating signals of the active switches, voltage stress of switches and inductors current in different operating modes under the step-up mode of the interleaved bidirectional DC-DC converter;

FIG. 4(a) is an equivalent circuit of the interleaved bidirectional DC-DC converter showing the operating mode 1 under the step-down mode of the invention;

FIG. 4(b) is an equivalent circuit of the interleaved bidirectional DC-DC converter showing the operating mode 2 and 4 under the step-down mode of the invention;

FIG. 4(c) is an equivalent circuit of the interleaved bidirectional DC-DC converter showing the operating mode 3 under the step-down mode of the invention; and

FIG. 5 key waveforms of the converter operating at CCM which include gating signals of the active switches, voltage stress of switches and inductors current in different operating modes under the step-down mode of the interleaved bidirectional DC-DC converter.

### DETAILED DESCRIPTION OF THE PREFERRED EMBODIMENT

The following content combines with the drawings and the embodiment for describing the present invention in detail.

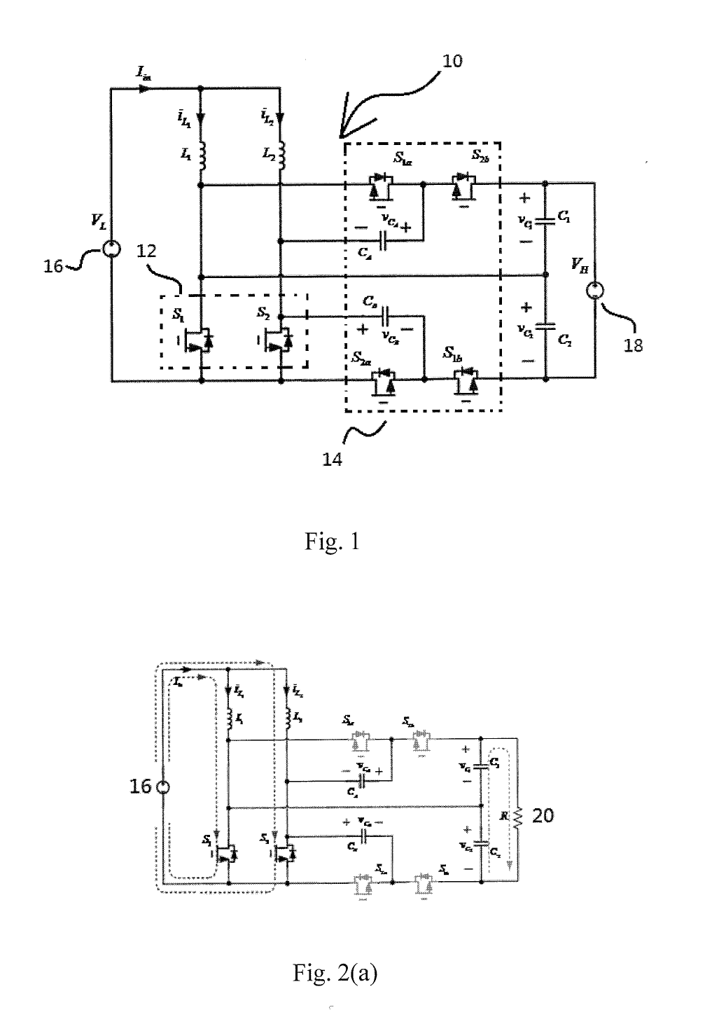

With reference to FIG. 1, the DC-DC converter 10 is comprised of a switch set 12 which have a first switch S₁ and a second switch S₂, an operating switch set 14 which have four operating switches, a first operating switch S₁ₐ, a second operating switch S_{1b}, a third operating switch S₂ₐ, and a fourth operating switch S_{2b}, two blocking capacitors C_{A} and C_{B}, two inductors L₁ and L₂ and two capacitors C₁ and C₂. Wherein, one end of the inductors L₁ and L₂ is connected to a first voltage source 16, and the other end of the inductors L₁ and L₂ is connected to the first switch S₁ and the second switch S₂ respectively. Two capacitors C₁ and C₂ are connected in series and the other end of the capacitors C₁ and C₂ is connected to second voltage source 18 in parallel. In order to simplify the circuit analysis of the invention converter, some assumptions are made as follows. All components are ideal components and the capacitors are sufficiently large, such that the voltages across them can consider as constant approximately.

### A. Step-Up Mode

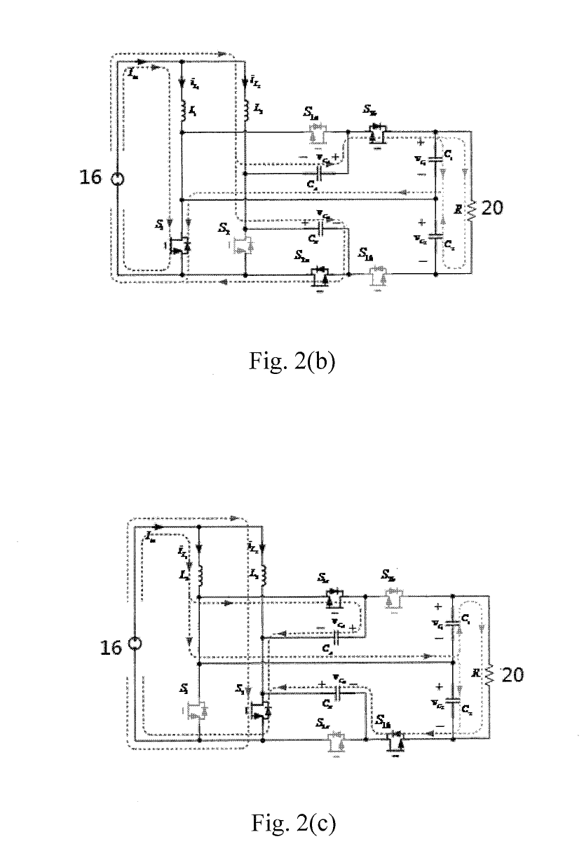

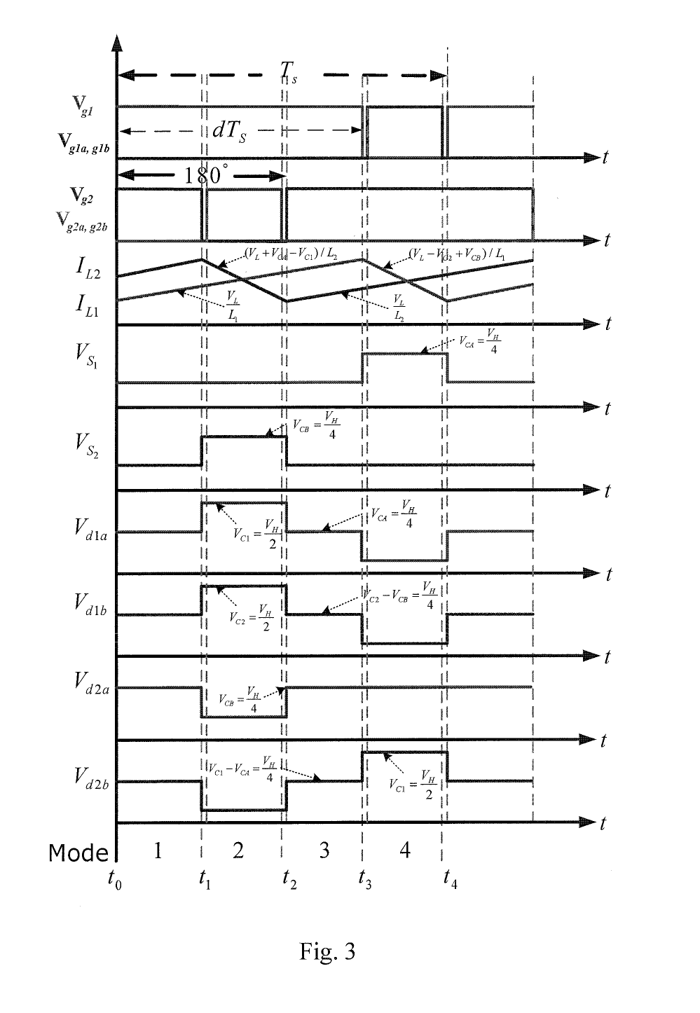

Some key waveforms of the converter under step-up mode are shown in FIG. 3 and the corresponding equivalent circuits are shown in FIG. 2(a)˜FIG. 2(c).

In one embodiment, that operation of active switches S₁ₐ and S_{1b} (S₂ₐ and S_{2b}) are complementary to S₁(S₂) and the phase shift between two phases is 180°. In the step-up mode, the first voltage source 16 is as an input voltage, the second voltage source 18 at the output side is replaced by a load 20. The capacitors C₁ and C₂ at the output side are as the output capacitors. The load 20 is connected to the capacitors C₁ and C₂. Prior to mode 1, the switches S₁ₐ and S_{1b} are turned off. During dead time the inductor current i_{L1} would be forced to flow through the body diodes of switch S₁ₐ and switch S_{1b} respectively. Also the inductor current i_{L2} flows through the switch S2.

At t₀, when into operating mode 1, switch S₁ is turned on. The current that had been flowing through the body diodes of the S₁ₐ and S_{1b} now flows switch S₁. Since both switches S₁ and S₂ are conducting, switches S₁ₐ, S_{1b}, S₂ₐ, and S_{2b} are all off. The corresponding equivalent circuit is shown in FIG. 2(a). From FIG. 2(a) it is seen that both i_{L1} and i_{L2} are increasing to store energy in L₁ and L₂ respectively. The voltages across switches S₁ₐ and S₂ clamped to capacitor voltage V_{CA} and V_{CB} respectively and the voltages across the switches S_{1b} and S_{2b} are clamped to V_{C2} minus V_{CB} and V_{C1} minus V_{CA} respectively. Also, the load 20 is supplied from capacitors C₁ and C₂.

At t₁, when into operating mode 2, switch S₂ is turned off. After a short dead time, S₂ₐ and S_{2b} are turned on while their body diodes are conducting. In other words, S₂ₐ and S_{2b} are turned on with zero voltage switching (ZVS). The corresponding equivalent circuit is shown in FIG. 2(b). It is seen from FIG. 2(b) that part of stored energy in inductor L₂ as well as the stored energy of C_{A} is now released to output capacitor C₁ and the load 20. Meanwhile, part of stored energy in inductor L₂ is stored in C_{B}. In this mode, capacitor voltage V_{C1} is equal to V_{CB} plus V_{CA}. During this mode, i_{L1} increases continuously and i_{L2} decreases linearly.

At t₂, when into operating mode 3, S₂ₐ and S_{2b} are turned off. After a short dead time, S₂ is turned on. The current that had been flowing through body diodes of S₂ₐ and S_{2b} flows into switch S₂. The corresponding equivalent circuit turns out to be the same as Mode 1.

At t₃, when into operating mode 4, S₁ is turned off. After a short dead time, S₁ₐ and S_{1b} are turned on while their body diodes are conducting. Similarly, S₁ₐ and S_{1b} are turned on with ZVS. The corresponding equivalent circuit is shown in FIG. 2(c). It is seen from FIG. 2(c) that part of stored energy in inductor L₁ as well as the stored energy of C_{B} is now released to output capacitor C₂ and the load 20. Meanwhile, part of stored energy in inductor L₁ is stored in C_{A}. In this mode the output capacitor voltage V_{C2} is equal to V_{CB} plus V_{CA}. During this mode, i_{L2} still increases continuously and i_{L1} decreases linearly.

### B. Step-Down Mode

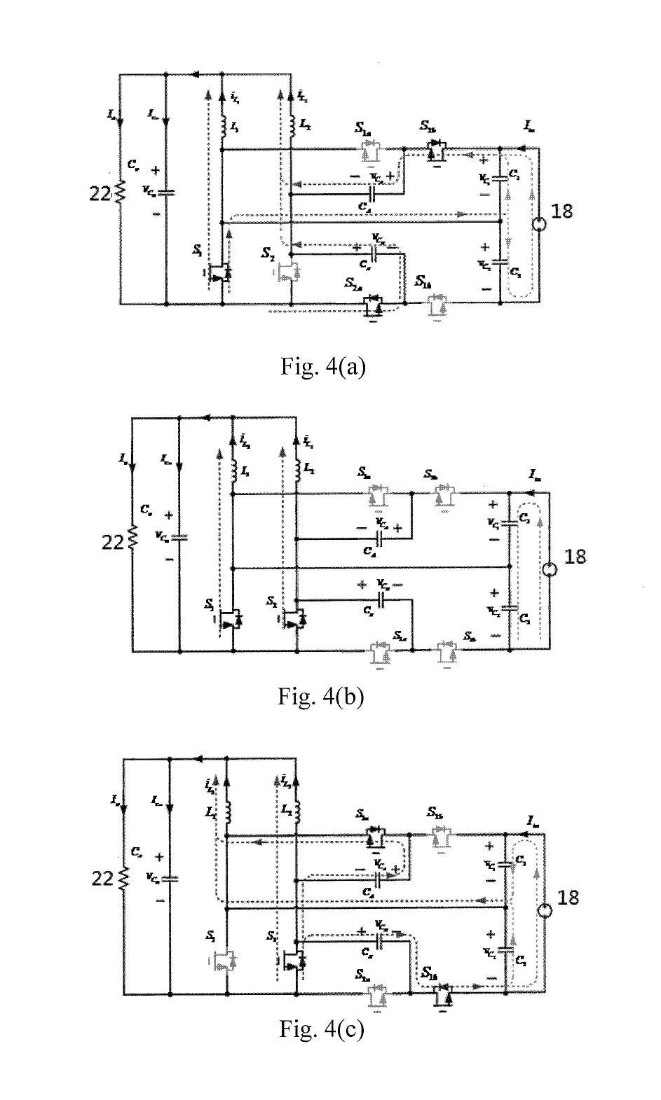

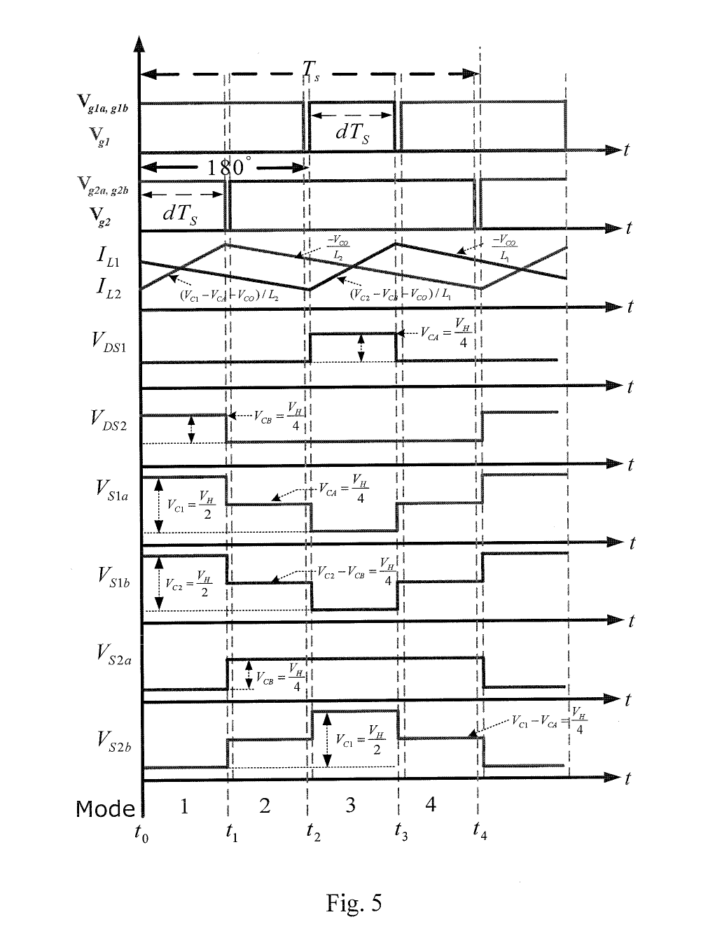

Some key waveforms of the converter under step-down mode are shown in FIG. 5 and the corresponding equivalent circuits are shown in FIG. 4(a)-FIG. 4(c).

In one embodiment, that operation of active switches S₁ₐ and S_{1b} (S₂ₐ and S_{2b}) are complementary to S₁(S₂) and the phase shift between two phases is 180°. In the step-down mode, when the interleaved bidirectional DC-DC converter 10 is operated as a step-down converter, the second voltage source 18 is as an input voltage, the first voltage source 16 at the input side is replaced by a load 22 and an output capacitor Co is connected in parallel. Prior to Mode 1, S₂ is off. During dead time inductor current i_{L2} would be forced to flow through the body diode of switch S₂ and inductor current i_{L1} still flows through the switch S₁.

At t₀, when into operating mode 1, S₂ₐ and S_{2b} are turned on. Current i_{L2} that had been flowing through the body diode of S₂ flows into S₁ and S₂ₐ. The corresponding equivalent circuit is shown in FIG. 4(a). From FIG. 4(a) one can see that during this mode current i_{L1} freewheels through S₁ and L₁ is releasing energy to the output capacitor C_{O} and the load 22. However, current i_{L2} provides two separate current paths through C_{A} and C_{B}. The first path starts from C₁, through S_{2b}, C_{A}, L₂, C_{O} and R, S₁ and then back to C₁ again. Hence, the stored energy of C₁ is discharged to C_{A}, L₂, and output capacitor C_{O} and the load 22. The second path starts from C_{B}, through L₂, C_{O} and R, S₂ₐ and then back to C_{B} again. In other words, the stored energy of C_{B} is discharged to L₂ and output capacitor C_{O} and the load 22. Therefore, during this mode, i_{L2} is increasing and i_{L1} is decreasing as can be seen from FIG. 5. Also, from FIG. 4(a), one can see that, V_{C1} is equal to V_{CA} plus V_{CB} due to conduction of S₂ₐ, S_{2b} and S₁. Since V_{C1}=V_{H}/2 (V_{H} is voltage source 18), and V_{CA}=V_{CB}=V_{C1}/2=V_{H}/4, one can observe from FIG. 4(a) that the voltage stress of S₂ is equal to V_{CH}=V_{H}/4 and the voltage stresses of S₁ₐ and S_{1b} are clamped to V_{C1}=V_{H}/2 and V_{C2}=V_{H}/2 respectively.

At t₁, when into operating mode 2, S₂ₐand S_{2b} are turned off. After a short dead time, S₂ is turned on while its body diode is conducting. In other words, S₂ is turned on with zero voltage switching (ZVS). The corresponding equivalent circuit is shown in FIG. 4(b). From FIG. 4(b), one can see that i_{L1} and i_{L2} are freewheeling through S₁ and S₂ respectively. Both V_{L1} and V_{L2} are equal to −V_{CO}, and hence, i_{L1} and i_{L2} decrease linearly. L₁ and L₂ are releasing energy to output capacitor C_{O} and the load 22. During this mode, the voltage across S_{2b}, namely V_{S2b}, is equal to the difference of V_{C1} and V_{CA} and V_{S2a} is clamped at V_{CB}. Similarly, the voltage across S_{1b}, namely V_{S1b}, is equal to the difference of V_{C2} and V_{CB} and V_{S1a} is clamped at V_{CA}.

At t₂, when into operating mode 3, S₁ is turned off and inductor current i_{L1} flows through the body diode of switch S₁. After a short dead time, S₁ₐ and S_{1b} are turned on. The current that had been flowing through the body diode of S₁ flows into S₂. The corresponding equivalent circuit is shown in FIG. 4(c). From FIG. 4(c) one can see that during this mode current i_{L2} freewheels through S₂ and L₂ is releasing energy to output load. However, current i_{L1} provides two separate current paths through C_{A} and C_{B}. The first path starts from C₂, through L₁, C_{O} and R, S₂, C_{B}, S_{1b}, and then back to C₂ again. Hence, the stored energy of C₂ is discharged to C_{B}, L₁ and output capacitor C_{O} and the load 22. The second path starts from C_{A}, through S₁ₐ, L1, C_{O} and R, S₂, and then back to C_{A} again. In other words, the stored energy of C_{A} is discharged to L₁ and output capacitor C_{O} and the load 22. Therefore, during this mode, i_{L1} is increasing and i_{L2} is decreasing as can be seen from FIG. 5. Also, from FIG. 4(c), one can see that, V_{C2} is equal to V_{CA} plus V_{CB} due to conduction of S₁ₐ and S_{1b}. Since V_{C2}=V_{H}/2, and V_{CA}=V_{CH}=V_{C2}/2=V_{H}/4, one can observe from FIG. 4(c) that the voltage stress of S₁ is equal to V_{CA}=V_{H}/4 and the voltage stresses of S_{2b} and S₂ₐ are clamped to V_{C1}=V_{H}/2 and V_{CB}=V_{H}/4 respectively.

At t₃, when into operating mode 4, S₁ₐ and S_{1b} are turned off. After a short dead time, S₁ is turned on while its body diode is conducting. Similarly, S₁ is turned on with zero voltage switching (ZVS). The corresponding equivalent circuit turns out to be the same as FIG. 4(b) and its operation is the same as that of mode 2.

In summary, in one embodiment, in the step-up mode, the high step-up voltage conversion ratio is 4*V_{L}/(1−D) times under the duty cycle (0.5<D<1). In the step-down mode, the high step-down conversion ratio is D*V_{H}/4 times under the duty cycle (0<D<0.5). According to the voltage adding and voltage dividing principle of the capacitor, the main purpose of the new capacitive switching circuit of the DC/DC converter is not only storing the energy in the blocking capacitor to increase the conversion ratio but also reducing the voltage stress of the active switches. As a result, the proposed converter topology possesses the low switch voltage stress characteristic. This will allow one to choose lower voltage rating MOSFETs to reduce both switching and conduction losses, and the overall efficiency is consequently improved. In addition, due to the charge balance of the blocking capacitor, the converter features both automatic uniform current sharing characteristic of the interleaved phases and without adding extra circuitry or complex control methods.

The present invention mainly is comprised of the internal capacitive switching circuit which equally distributes the charge energy on the interleaved input/output inductor circuits so as to achieve active current sharing on the inductor circuits so that it can reduce conduction losses and increase the conversion efficiency of the converter.

For demonstrating the performance of the invention converter, the invention converter is compared with conventional boost DC-DC converter, as shown in Table 1, wherein, D is the duty cycle.

Table. 1 summarizes the voltage conversion ratio and normalized voltage stress of active switches for reference. It shows a comparison table for the interleaved bidirectional DC-DC converter under step-up mode according to an embodiment of the present invention and the conventional boost DC-DC converter.

TABLE 1
Comparison of the steady state characteristics for four converter.

| | | | | An embodi- |
|---|---|---|---|---|
| | | High | Ultra high | ment of the |
| Gain/voltage | Voltage | boost ratio | boost ratio | present |
| stress | doubler | converter | converter | invention |
| Conversion | 2/(1 − D) | (3 − D)/(1 − D) | (3 + D)/(1 − D) | 4/(1 − D) |
| ratio | | | | |
| The voltage | 1/2 | 1/(3 − D) | 2/(3 + D) | 1/4 |
| stress on | | | | |
| the switch | | | | |
| of the low | | | | |
| voltage side | | | | |
| The voltage | 1 | 2/(3 − D) | 2/(3 + D) | 1/2 |
| stress on | | | | |
| the switch | | | | |
| of the high | | | | |
| voltage side | | | | |

For demonstrating the performance of the invention converter, the invention converter is also compared with conventional buck DC-DC converter, as shown in Table 2, wherein, D is the duty cycle.

Table. 2 summarizes the voltage conversion ratio and normalized voltage stress of active switches for reference. It shows a comparison table for the interleaved bidirectional DC-DC converter under step-down mode according to an embodiment of the present invention and the conventional buck DC-DC converter.

TABLE 2
Comparison of the steady state characteristics for three converter.

| | Traditional | Interleaved | | |
|---|---|---|---|---|
| | interleaved | buck converter | An embodiment | |
| Gain/Voltage | buck | with expanded | of the present | |
| stress | converter | duty cycle | invention | |
| Conversion ratio | D | D/2 | D/4 | |
| The voltage stress | 1 | 1/2 | S₁ₐ | 1/2 |
| on the switch Sₐ of | | | S₂ₐ | 1/4 |
| the high voltage | | | | |
| side | | | | |
| The voltage stress | 1 | 1 | S_{1b} | 1/2 |
| on the switch S_{b} of | | | S_{2b} | |
| the high voltage | | | | |
| side | | | | |

| | | | |
|---|---|---|---|
| The voltage stress | 1 | 1/2 | 1/4 |
| on the switch of the | | | |
| low voltage side | | | |

The present invention discloses a simple, practical and effective bidirectional DC-DC converter. The converter is comprised of six switches, two capacitors, and two inductors to form a bidirectional boost-buck converter circuit, which can effectively increase the performance, the ratio for boost or buck, the life time, and decreases the requirement for the sustain voltage of the components and system costs.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

1. A bidirectional DC-DC converter, comprising:
a voltage source for providing an input voltage;
an energy storage set connected to the voltage source and receiving the input voltage;
a switch set including a first switch and a second switch, wherein the first switch and the second switch are respectively connected to the energy storage set;
an operating switch set connected to the switch set, wherein the operating switch set includes a first operating switch, a second operating switch, a third operating switch and a fourth operating switch;
a blocking capacitor set respectively connected to the switch set and the operating switch set; and
an output capacitor receiving energy from the energy storage set and the input voltage providing a power to a load;
wherein, the first operating switch and the second operating switch are driven complementarily with the first switch, and the third operating switch and the fourth operating switch are driven complementarily with the second switch.

2. The bidirectional DC-DC converter according to claim 1, wherein, an interleaved phase shift between a phase of the first operating switch and the second operating switch and a phase of the first switch is 180°.

3. The bidirectional DC-DC converter according to claim 1, wherein, the energy storage set comprise a capacitor set and an inductor set.

4. The bidirectional DC-DC converter according to claim 3, wherein, when the bidirectional DC-DC converter is operated under a step-up mode, the capacitor set is connected to the load, and the inductor set provides the stored energy, and controlling the operating switch set to make the blocking capacitor set in series so that a voltage adding effect produced on a voltage of the capacitor set in order to provide the high voltage power to the load.

5. The bidirectional DC-DC converter according to claim 3, wherein, when the bidirectional DC-DC converter is operated under a step-down mode, the capacitor set is connected to the voltage source, and the inductor set connects to the load and the output capacitor, and controlling the operating switch set to make the blocking capacitor set in series so that a voltage dividing effect produced on a voltage of the output side in order to deliver the energy to the output capacitor for providing the low voltage power to the load.

6. The bidirectional DC-DC converter according to claim 1, wherein, the energy stored in the energy storage set can be stored in the blocking capacitor set to increase a voltage conversion ratio.

7. The bidirectional DC-DC converter according to claim 1, wherein, when the bidirectional DC-DC converter is operated under a step-up mode, the load obtains a voltage conversion ratio of 4*V_{L}/(1−D) times in a duty cycle between 0.5 to 1, wherein, the V_{L} is a voltage value of the voltage source.

8. The bidirectional DC-DC converter according to claim 1, wherein, when the bidirectional DC-DC converter is operated under a step-down mode, the load obtains a voltage conversion ratio of D*V_{H}/4 times in a duty cycle between 0 to 0.5, wherein, the V_{H} is a voltage value of the voltage source.
